(19) United States
(12) Patent Application Publication
(10) Pub. No.: US 2005/0008938 A1
(43) Pub. Date: Jan. 13, 2005

(54) Negative electrode for rechargeable lithium battery, method of producing same and rechargeable lithium battery comprising same

(75) Inventors: Chung-Kun Cho, Suwon-city (KR); Duck-Chul Hwang, Suwon-city (KR); Seung-Sik Hwang, Seongnam-city (KR); Sang-Mock Lee, Suwon-city (KR)

Correspondence Address: STAAS & HALSEY LLP, SUITE 700, 1201 NEW YORK AVENUE, N.W., WASHINGTON, DC, 20005, US

(73) Assignee: SAMSUNG SDI CO., LTD., Suwon-si (KR)

(21) Appl. No.: 10/778,319

(22) Filed: Feb. 17, 2004

(30) Foreign Application Priority Data
Jul. 8, 2003 (KR) 2003-46160

(51) Int. Cl. H01M 2/16; H01M 2/18

(52) U.S. Cl. 429/246; 429/144; 429/249

(57) ABSTRACT

A negative electrode of a rechargeable lithium battery includes a current collector, a negative active material layer on one side of the current collector, a protection layer on the negative active material and a releasing layer on the other side of the current collector, or on the protection layer.

### CROSS-REFERENCE TO RELATED APPLICATIONS

This application is based on application No. 2003-46160, filed in the Korean Intellectual Property Office on Jul. 8, 2003, the disclosure of which is incorporated hereinto by reference.

### BACKGROUND OF THE INVENTION

1. Field of the Invention

The present invention relates to a negative electrode for a rechargeable lithium battery, a method of producing the same, and a rechargeable lithium battery comprising the same. More particularly, it relates to a negative electrode for a rechargeable lithium battery that prevents internal short-circuits and provides batteries exhibiting improved cycle life characteristics, a method of producing the same, and a rechargeable lithium battery comprising the same.

2. Description of the Related Art

The continued development of portable electronic devices has led to a corresponding increase in the demand for rechargeable batteries having both a lighter weight and a higher capacity. To satisfy such demands, the most promising approaches are rechargeable lithium batteries such as lithium-sulfur batteries and lithium ion batteries. Among these rechargeable lithium batteries, lithium-sulfur batteries have become very attractive because they have a higher capacity than lithium ion batteries.

Lithium-sulfur batteries use sulfur-based compounds with sulfur-sulfur bonds as a positive active material, and a lithium metal or a carbon-based compound as a negative active material. The carbon-based compound is one that reversibly intercalates or deintercalates metal ions, such as lithium ions. Upon discharging (i.e., electrochemical reduction), the sulfur-sulfur bonds are cleaved, resulting in a decrease in the oxidation number of the sulfur (S). Upon recharging (i.e., electrochemical oxidation), the sulfur-sulfur bonds are re-formed, resulting in an increase in the oxidation number of the S. The electrical energy is stored in the battery as chemical energy during charging, and is converted back to electrical energy during discharging.

The lighter and higher energy density of lithium metal makes it widely used as a negative active material for a lithium-sulfur battery. The lithium metal acts as the active material as well as a current collector, so it may be used without an additional current collector in the lithium-sulfur battery. However, for consideration of cycle life characteristics, a metal-deposited polymer current collector is suitably used. The polymer may be polyethyleneterephthalate, polypropylene, polyethylene, polyvinylchloride, polyolefin, or polyimide, and the metal may be copper.

Even though the current collector is used, the high reactivity of lithium metal still manifests regarding the cycle life characteristics. Recently, studies regarding protection layers for covering the lithium metal and inhibiting the reaction of the lithium metal have been undertaken. Such a protection layer may comprise an organic or inorganic, protection layer or layers or an organic/inorganic hybrid thin layer. An example thereof may be a polyethylene oxide layer.

However, the protection layer adheres to the polymer film, which may be cause problems during large-scale battery fabrication, because the electrode is produced and stored with the condition of the direct contact between the protection layer and the polymer current collector. That is, in production on a large scale, an electrode that is considerably longer than an eventually desired size is generally produced on a conveyer and wound by a roller. In addition, the resulting negative electrode is stored in a wound state, and then it is unwound, followed by cutting to a desired electrode size for fabricating batteries.

Such direct contact causes the protection layer to stick on the polymer current collector so that the protection layer is partly separated from the lithium metal and adhered to the polymer current collector. Accordingly, the surface of the lithium metal is partly exposed and the exposed surface reacts with electrolyte, causing formation of dendrites resulting in occurrence of internal short-circuits and deterioration of cycle life characteristics.

### SUMMARY OF THE INVENTION

It is an aspect of the present invention to provide a negative electrode for a rechargeable lithium battery with a protection layer that is covered with a release layer that prevents damage thereto and completely prevents reaction between a negative active material and an electrolyte.

It is another aspect to provide a method of producing the negative electrode.

It is still another aspect to provide a rechargeable lithium battery including the negative electrode.

These and/or other aspects may be achieved by a negative electrode for a rechargeable lithium battery, including a current collector, a negative active material layer on one side of the current collector, a protection layer on the negative active material, and a release layer on the other side of the current collector or on the protection layer.

To achieve these and/or other aspects, the present invention provides a rechargeable lithium battery including the negative electrode, a positive electrode including a positive active material, and an electrolyte.

The present invention further includes a method of producing a negative electrode for a rechargeable lithium battery. In this method, a negative active material layer is formed on a current collector, a protection layer is formed on the negative active material, and a release paper or a release film is covered on the protection layer to form a releasing layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a schematic cross-sectional view showing a negative electrode of a rechargeable lithium battery according to an embodiment of the present invention;

FIG. 1B is a schematic cross-sectional view showing a negative electrode of a rechargeable lithium battery according to another embodiment of the present invention;

FIG. 2 is a schematic cross-sectional view showing a negative electrode of a rechargeable lithium battery according to another embodiment of the present invention;

FIG. 3A is a schematic drawing illustrating a wound negative electrode according to one embodiment of the present invention;

FIG. 3B is a schematic drawing illustrating a wound negative electrode according to another embodiment of the present invention;

FIG. 4A is a photograph of a negative electrode according to Comparative Example 1 after the adhesion test; and

FIG. 4B is a photograph of a negative electrode according to Example 1 of the present invention after the adhesion test.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention relates to a negative electrode of a rechargeable lithium battery. The negative electrode has a release layer that covers the electrode to prevent contact between a protection layer and a current collector, and that prevents damage to the protection layer.

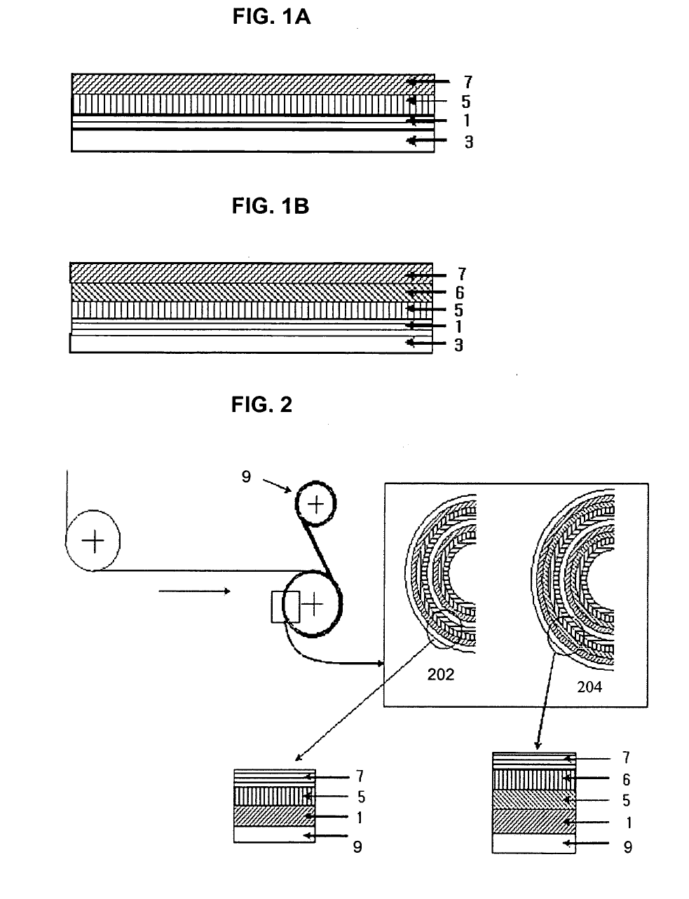

One embodiment of the negative electrode of the present invention includes a current collector 1, a release layer 3 on one side of the current collector 1, a negative active material 5 on the other side of the current collector 1, and a protection layer 7 on the negative active material 5, as shown in FIG. 1A.

The release layer 3 is formed of any material that has releasing properties and does not deteriorate battery performance. Examples thereof are a silicon-included compound, polyalkylene oxide, polyolefin, polydiene, polyfluorocarbon, a mixture thereof, and a copolymer thereof. The silicon-included compound is preferred. The silicon-included compound is represented by formula 1. 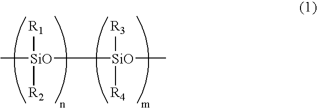
where R₁, R₂, R₃, and R₄ are identically or independently selected from C₁-C₁₈ linear alkyl, or branched alkyl, cyclic alkyl, alkenyl, aryl, aralkyl, halogenated alkyl, halogenated aryl, halogenated aralkyl, phenyl, mercaptan, methacrylate, acrylate, epoxy, or vinyl ether; and n and m are the same or different integers of 1 to 100,000.

The release layer 3 is formed on one side of the current collector 1, and it prevents direct contact between the current collector 1 and the protection layer 7 when wound for transporting or storing of the negative electrode. Thus, the release layer solves the problems associated with the direct contact between the current collector 1 and the protection layer 7, which cause the separation of the protection layer from the negative active material layer so that the exposed negative active material layer reacts with an electrolyte.

The release layer 3 generally has a thickness of 0.1 to 5.0 μm. If the thickness of the release layer is less than 0.1 μm, the effect by the release layer is not achieved. If the thickness of the release layer is more than 5.0 μm, the energy density of the battery is reduced.

The release layer is formed on the current collector by a general coating technique such as roll coating, spray coating, gravure coating, reverse gravure coating, mayer bar coating, direct roll coating, reverse roll coating, spray coating, gravure roll coating, gap coating, and slot die coating. Alternatively, the release layer on a polymer film may also be available through commercial purchase.

The current collector 1 may be a polymer film which supports the negative active material and does not participate in the battery reaction, and generally the polymer film is deposited with a metal. Examples of the polymer include, but are not limited to, polyester, polyethylene, polypropylene, or polyimide. The metal may be any metal that does not form an alloy with lithium, and examples thereof are Cu, Ni, Ti, Ag, Au, Pt, Fe, Co, Cr, W, or Mo.

The negative electrode of an embodiment of the present invention includes a negative active material 5 on a side of the current collector 1 that is opposite to the releasing layer 3. The negative active material layer 5 includes a negative active material selected from a lithium metal, a lithium alloy, or a material that reacts with lithium ions to form a lithium-containing compound.

Examples of the material that reacts with lithium ions to form a lithium-containing compound include, but are not limited to, tin oxide (SnO₂), titanium nitrate and Si. The lithium alloys include an alloy of lithium and a metal selected from Na, K, Rb, Cs, Fr, Be, Mg, Ca, Sr, Ba, Ra, Al, and Sn.

A surface of the negative active material layer 5 is formed with the protection layer 7, to prevent direct contact between the negative active material 5 and an electrolyte, which causes unevenness in current density on a surface of the electrode and formation of dendrites. The dendrites cause internal short circuits, thus reducing capacity and cycle life characteristics.

The protection layer includes an ionic conductive polymer, and examples may be polyethylene oxides, siloxanes, phosphazenes, or aluminates such as polyethylene oxide, polypropylene oxide, poly[bis(2-(2-methoxyethoxy)phosphazene)], aryloxyphosphazene, poly(methylalkoxysilane), and poly(aluminosilicate). The protection layer may be formed by general techniques using a polymer solution obtained from the addition of the ionic conductive polymer to a solvent.

Examples of the coating process include knife coating, direct roll coating, reverse roll coating, gravure roll coating, gap coating, spray coating, and slot die coating. Slot die coating or gravure roll coating are preferred because they form protection in the form of a thin film. The polymer solution may be in the form of a dispersion in which the polymer micro-particles are dispersed in the solvent, or in the form of a solution in which the polymer is completely dissolved in the solvent. The solution in which the polymer is completely dissolved in the solvent is preferable because it forms a dense layer. The solvent is preferably a solvent having a low boiling point, which allows easy removing without residue, and is more preferably an electrolytic solvent. Useful solvents include dioxolane, dimethoxyethane, acetonitrile, dimethyl carbonate, and tetrahydrofuran.

The obtained protection layer should have properties required for a polymer electrolyte, such as electrochemical stability, ionic conductivity, and resistance to electrolytic solvents.

In particular, the protection layer may be hardened to improve resistance to electrolytic solvents and increase mechanical properties. The hardening time may be greatly reduced by the subsequent covering operation of the release paper or the release film to effectively intercept ambient air. Generally, high adhesion of the protection layer makes it firmly stick on the release paper or the release film. Hardening process examples include thermal-hardening, ultraviolet-hardening, and electric beam-hardening.

The protection layer is preferably 0.1 to 10 μm thick, and more typically 0.1 to 5 μm thick, for adequate ionic conductivity and energy density. A thickness of more than 10 μm causes internal resistance and over-voltage, and if the thickness of the protection layer is thinner than 0.1 μm, it makes complete and uniform covering by the protection layer on the negative active material difficult.

Alternatively, the negative electrode of an embodiment of the present invention may further include a pre-treatment layer 6 between the negative active material 5 and the protection layer 7 as shown in FIG. 1B. The pre-treatment layer 6 acts to decrease reactivity of the negative active material and removes a potential for reaction between the solvent for coating the protection layer and the negative active material. The pre-treatment layer 6 may be formed by plasma-treating the electrode with the release layer, the current collector, and the active material layer using a gas such as oxygen, nitrogen, or carbon dioxide, or by exposing the electrode to the gas. Alternatively, the pre-treatment layer may be formed by depositing a metal that forms an alloy with lithium, or a metal that fails to alloy with lithium. The pre-treatment layer may also be formed by depositing an inorganic material. The metal that forms an alloy with lithium may be Al, Mg, K, Na, Ca, Sr, Ba, Si, Ge, Sb, Pb, In, or Zn, and the metal that fails to alloy with lithium may be Ni, Ti, Cu, Ag, Au, Pt, Fe, Co, Cr, W, or Mo.

The inorganic material may be lithium nitride, lithium carbonate, lithium silicate, lithium borate, lithium aluminate, lithium phosphate, lithium phosphorous oxynitride, lithium silicosulfide, lithium germanosulfide, lithium lanthanum oxide, lithium titanium oxide, lithium borosulfide, lithium aluminosulfide, lithium phosphosulfide, or a mixture thereof.

High ionic conductivity is a desired, but not indispensable condition for the pre-treatment layer. Thus, even if it has no ionic conductivity, as long as the pretreatment layer is deposited in the form of a thin layer, it can be used as the pre-treatment layer. The pre-treatment layer generally has a thickness of several nm to 3 μm, and more generally a significant number of nm to 1 μm. If the thickness is less than several nm, the pre-treatment layer is not sufficiently covered on the negative active material layer so that it does not effectively reduce the reactivity of the negative active material layer. If the thickness is more than 3 μm, it is unfavorable in terms of energy density.

Another embodiment of the present invention uses a release paper 9 or a release film 9. That is, the effect by the release layer of the present invention is realized by covering a release paper 9 or a release film 9 on a surface of a conventional negative electrode with the current collector, a negative active material layer, and a protection layer, and alternatively, a pre-treatment layer is coated with a protection layer and is then dried in a drying oven to remove solvents using a press roller, as shown in (202) and (204) of FIG. 2. In the fabrication of batteries, the release paper or release film should be removed from the protection layer to allow transferring of lithium ions, and the release paper or release film should not be present in the resulting batteries. The removed release paper or release film may be reused.

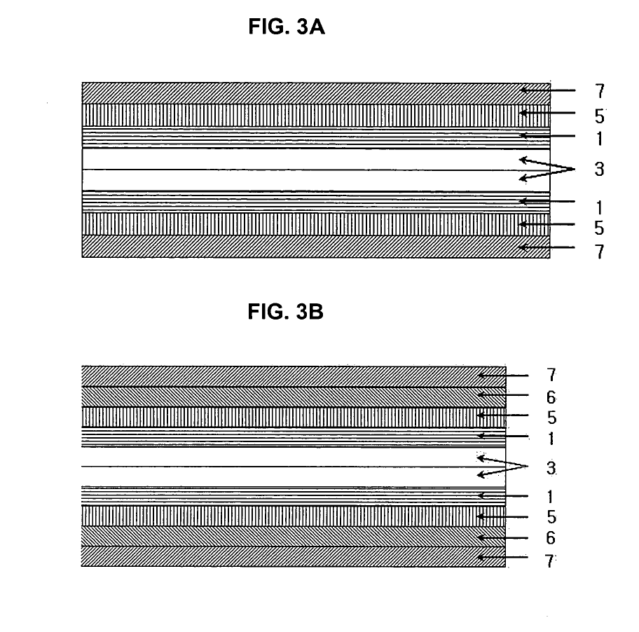

It is not necessary to perform the process using the release agent and the process using the release paper or the release film together, because the winding for storage or transport is performed by contacting a release layer of one electrode with a release layer of another electrode, as shown in FIGS. 3A and 3B.

A rechargeable battery with the negative electrode of an embodiment of the present invention includes a positive electrode and an electrolyte. The positive electrode includes a positive active material, which includes elemental sulfur (S₈), a sulfur-based compound, or a mixture thereof. The sulfur-based compound is selected from an organic-sulfur compound or a carbon-sulfur polymer ((C₂Sₓ)ₙ:x=2.5 to 50, n≧2). Alternatively, the positive active material may include lithiated metal oxides in which lithium intercalation reversibly occurs. That is, all positive active materials used in rechargeable lithium batteries may be used in the present invention.

The electrolyte includes an electrolytic salt and an organic solvent.

The organic solvent may be a sole solvent or a mixed organic solvent with at least two components. The mixed organic solvent includes at least two groups selected from a weak polar solvent group, a strong polar solvent group, or a lithium protection group.

The term “weak polar solvent”, as used herein, is defined as a solvent that dissolves elemental sulfur and that has a dielectric coefficient of less than 15. The weak polar solvent is selected from aryl compounds, bicyclic ether, or acyclic carbonate compounds. The term “strong polar solvent”, as used herein, is defined as a solvent that dissolves lithium polysulfide and that has a dielectric coefficient of more than 15. The strong polar solvent is selected from bicyclic carbonate compounds, sulfoxide compounds, lactone compounds, ketone compounds, ester compounds, sulfate compounds, or sulfite compounds. The term “lithium protection solvent”, as used herein, is defined as a solvent that forms a good protection layer, i.e., a stable solid-electrolyte interface (SEI) layer, on a lithium surface, and which shows a cyclic efficiency of at least 50%. The lithium protection solvent is selected from saturated ether compounds, unsaturated ether compounds, or heterocyclic compounds including N, O, and S.

Examples of the weak polar solvents include xylene, dimethoxyethane, 2-methyltetrahydrofuran, diethyl carbonate, dimethyl carbonate, toluene, dimethyl ether, diethyl ether, diglym, or tetraglyme.

Examples of the strong polar solvents include hexamethyl phosphoric triamide, γ-butyrolactone, acetonitrile, ethylene carbonate, propylene carbonate, N-methyl pyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, or ethylene glycol sulfite.

Examples of the lithium protection solvents include tetrahydrofuran, 1,3-dioxolane, 3,5-dimethylisoxazole, 2,5-dimethyl furan, furan, 2-methyl furan, 1,4-oxane, and 4-methyldioxolane.

Examples of electrolyte salts include lithium trifluoromethane sulfonimide, lithium triflate, lithium perchlorate, LiPF₆, LiBF₄, tetraalkylammonium salts such as tetrabutylammonium tetrafluoroborate (TBABF₄), liquid state salts at room temperature, e.g.,an imidazolium salt such as 1 -ethyl-3-methylimidazolium Bis-(perfluoroethyl sulfonyl) imide (EMIBeti), or a combination thereof.

The following examples illustrate the present invention in further detail, but it is understood that the present invention is not limited by these examples.

### COMPARATIVE EXAMPLE 1

1.25 g of amorphous polyethylene oxide and 0.545 g of a LiN(CF₃SO₂)₂ lithium salt were admixed to 19 g of acetonitrile and uniformly shaken to prepare a polymer solution. The polymer solution was coated on a glass with a width of 3 cm and a length of 3 cm. It was dried at room temperature for 1 hour, and then dried under vacuum for 1 hour to form a protection layer on the glass. A polyethylene terephthalate film was positioned on the protection layer and pressed followed by stripping. As a result, the protection layer was mostly separated from the glass, and the separated protection layer was stuck on the polyethylene terephthalate film.

### COMPARATIVE EXAMPLE 2

Polymer solutions were prepared by the same procedure as in Example 1 except that the mixing ratio of [ethylene oxide] to [Li⁺] was changed to mole ratios of 10, 15 and 20, respectively. The coating process was performed using a spin coater at a rate of 1,000 rpm for 60 seconds. The drying process was performed at room temperature for 1 hour and under a vacuum for 2 hours. A polyethylene terephthalate film was positioned on the resulting glass and pressed followed by stripping. As a result, the protection layers were mostly separated from the glass and the separated protection layers were stuck on the polyethylene terephthalate film, regardless of the amount of lithium salt.

### COMPARATIVE EXAMPLE 3

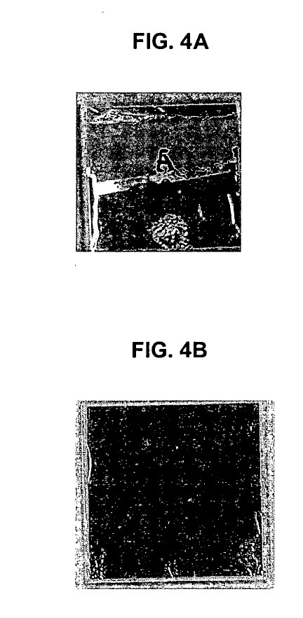

1.25 g of amorphous polyethylene oxide and 0.545 g of a LiN(CF₃SO₂)₂ lithium salt were admixed to 19 g of acetonitrile and uniformly shaken to prepare a polymer solution. The polymer solution was coated on a copper-deposited glass with a width of 3 cm and a length of 3 cm. It was dried at room temperature for 1 hour, and repeatedly dried under a vacuum for 1 hour to form a protection layer on the copper-deposited glass. A polyethylene terephthalate film was positioned on the protection layer and pressed followed by stripping. As a result, the protection layer was mostly separated from the copper-deposited glass, and the separated protection layer, as well as copper, was stuck on the polyethylene terephthalate film as shown in FIG. 4A.

### EXAMPLE 1

As a release agent, a silicon resin composition (included 22.5 wt % of SYL-OFF 7900 (trade-mark DOW CORNING CORPORATION), 2.5 wt % of SYL-OFF 7922 (trade-mark DOW CORNING CORPORATION) and 75 wt % of water) was coated on a polyethylene terephthalate film by a mayer bar coating procedure. The coated polyethylene terephthalate film was dried at a temperature of 180° C. in an oven for 2 minutes to produce a release-treated polyethylene terephthalate film coated with a silicon release layer having a thickness of 0.3 μm.

The release-treated polyethylene terephthalate film was positioned on the protection layer on the copper-deposited glass according to Comparative Example 3 and pressed, followed by stripping. As a result, the protection layer was not separated from the copper-deposited glass, as shown in FIG. 4B.

### EXAMPLE 2

Copper was deposited on the side of the release-treated polyethylene terephthalate film opposite the side that was coated with the silicon release layer produced according to Example 1. At this time, the thickness of the copper layer was controlled to 3000 Å. Thereafter, a lithium metal was deposited on the copper layer until its thickness reached 5 μm to produce a four-layered product (release layer/polyethylene terephthalate film/copper layer/lithium metal layer). The polymer solution produced according to Comparative Example 1 was coated on the lithium metal layer and dried at room temperature for 1 hour, followed by re-drying under a vacuum for 1 hour to produce a five-layered product (negative electrode) of release layer/polyethylene terephthalate film/copper layer/lithium metal layer and the protection layer.

The negative electrode was wound using a plastic stick by hand and then unwound. As a result, the coated protection layer was clearly maintained without damage.

### EXAMPLE 3

An elemental qualitative analysis using XPS (X-ray Photo-electron Spectroscopy) was performed on the release layer and the protection layer of the negative electrode according to Example 2, after it was cut. This analysis was performed to identify the presence of the release agent on a surface of the polymer layer. The results are shown in Table 1. It is evident from Table 1 that silicon, which was the main component of the release agent, was not present on the surface of the polymer layer. The results indicate the absence of the releasing agent on a surface of the polymer layer.

TABLE 1
Elemental qualitative analysis (% atomic concentration)

| | C1s | F1s | N1s | O1s | P2p | S2p | Si2p |
|---|---|---|---|---|---|---|---|
| Releasing treated part | 46.6 | | | 27.3 | | | 26.1 |
| Polymer layer | 50.2 | 10.5 | 1.3 | 34.2 | 0.5 | 2.7 | 0.2 |
| Polymer layer (after | 71.1 | 7.6 | 1.2 | 16.3 | 0.0 | 3.8 | 0.0 |
| argon etch) | | | | | | | |

### EXAMPLE 4

A release-treated polyethylene terephthalate film was produced by the same procedure as in Example 1, except that a polyethylene release agent was coated on a polyethylene terephthalate film.

### EXAMPLE 5

A release-treated polyethylene terephthalate film was produced by the same procedure as in Example 1, except that a polypropylene release agent was coated on a polyethylene terephthalate film.

### EXAMPLE 6

A release-treated polyethylene terephthalate film was produced by the same procedure as in Example 1, except that a polyfluorocarbon release agent was coated on a polyethylene terephthalate film.

The same analysis as in Example 3 was performed on the release-treated polyethylene terephthalate films according to Examples 4 to 6, and the same results as shown in Table 3 were found.

### EXAMPLE 7

Copper was deposited on the release-treated polyethylene terephthalate film produced according to Example 1 to produce a current collector. A lithium metal negative active material layer was formed on the current collector. A solution of polyethylene oxide in acetonitrile solvent was coated on the negative active material layer to form a protection layer. As a result, a negative electrode with the releasing layer/ the current collector/ the negative active material/ and the protection layer was obtained.

### EXAMPLE 8

Copper was deposited on a polyethylene terephthalate film to produce a current collector. A lithium metal negative active material layer was formed on the current collector. A solution of polyethylene oxide in an acetonitrile solvent was coated on the negative active material layer to form a protection layer. A silicone resin film was covered on the protection layer to produce a negative electrode. Using the negative electrode after stripping of the resin film, a lithium cell was fabricated by the general procedure. In the lithium cell, the silicone resin film was not present

### COMPARATIVE EXAMPLE 4

Copper was deposited on a polyethylene terephthalate film until the thickness reached 3000 Å to produce a current collector. A lithium metal negative active material layer with a thickness of 20 μm was formed on the current collector. A solution of polyethylene oxide in an acetonitrile solvent was coated using a slot die coater to form a protection layer with a thickness of 1 μm. During the ongoing coating process, polyethylene oxide direct contacted polyethylene terephthalate to damage a surface of the polyethylene because of a conveyer in which the current collector was positioned to be wound.

### EXAMPLE 9

A silicon resin composition (including 22.5 wt % of Syl-off 7900, 2.5 wt % of SYL-OFF 7922, and 75 wt % of water) was coated on one side of a polyethylene terephthalate film using a slot die coater and dried to a release-treated polyethylene terephthalate film with a thickness of 0.3 μm. Copper with a thickness of 3000 Å was deposited on the other side of the film to produce a current collector. A lithium metal negative active material with a thickness of 20 μm was formed on the current collector.

Thereafter, a solution of polyethylene oxide in an acetonitrile solvent was coated on the negative active material layer using a slot die coater to form a protection layer with a thickness of 1 μm. All processes were performed while the material such as film, etc. was placed on a conveyer and wound by a roller as in the general electrode production process. When the electrode is wound, the polyethylene oxide contacts the silicon resin layer so that it prevents shortcomings associated with the contact between the polyethylene oxide and the polyethylene terephthalate film.

Using the negative electrodes according to Comparative Example 4 and Example 9, lithium-sulfur pouch-type cells were fabricated by the general procedure. A positive electrode was produced by mixing 60 wt % of an elemental sulfur (S₈) positive active material, 20 wt % of a carbon conductive agent, and 20 wt % of a polyvinylpyrrolidone binder in an isopropyl alcohol solvent to prepare a positive active material slurry and coating the slurry on a carbon-coated Al current collector followed by drying it at room temperature for 2 hours and re-drying the same at 50 ° C. for 12 hours. The size of the positive electrodes was 25 mm×50 mm. The cells were test cells with a higher capacity than a coin cell. As an electrolyte, a 1 M LiN(SO₂CF₃)₂ in a mixed solvent of dimethoxy ethane and 1,3-dioxolane (80:20 volume ratio) was used.

The cells were charged at 0.2 C and discharged at 0.5 C and the capacity and the cycle life characteristics were measured. The results are shown in Table 2.

TABLE 2

| | Capacity at 1st | Capacity at 20^{th} | Cycle life at 20th |
|---|---|---|---|
| | cycle (mAh/g) | cycle (mAh/g) | cycles (%) |
| Comparative | 825 | 636 | 77 |
| Example 4 | | | |
| Example 9 | 830 | 825 | 99 |

It is evident from Table 2 that the cell according to Example 9, with the protection layer without damage, has an initial capacity corresponding to that of Comparative Example 4 with the protection layer with damage, but it has a significantly improved cycle life in comparison.

The releasing layer in the negative electrode of an embodiment of the present invention prevents damage of the protection layer, thus solving shortcomings associated with the negative active material and the electrolyte, such as occurrence of internal short-circuits and decrease in capacity and cycle life.

Although a few embodiments of the present invention have been shown and described, it would be appreciated by those skilled in the art that changes may be made in these embodiments without departing from the principles and spirit of the invention, the scope of which is defined in the claims and their equivalents.

1. A negative electrode of a rechargeable lithium battery comprising:
a current collector;
a negative active material layer on one side of the current collector;
a protection layer on the negative active material; and
a releasing layer on the other side of the current collector, or on the protection layer.

2. The negative electrode of claim 1, wherein the releasing layer comprises a material selected from the group consisting of a silicon-included compound, polyalkylene oxide, polyolefin, polydiene, polyfluorocarbon, a mixture thereof, and a copolymer thereof.

3. The negative electrode of claim 2, wherein the releasing layer includes the silicon-included compound.

4. The negative electrode of claim 3, wherein the silicon-included compound is represented by formula 1: 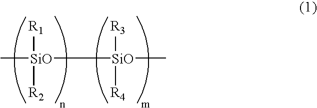
where R₁, R₂, R₃, and R₄ are identically or independently selected from the group consisting of C₁-C₁₈ linear alkyl, or branched alkyl, cyclic alkyl, alkenyl, aryl, aralkyl, halogenated alkyl, halogenated aryl, halogenated aralkyl, phenyl, mercaptan, methacrylate, acrylate, epoxy and vinyl ether; and
n and m are the same or different integers of 1 to 100,000.

5. The negative electrode of claim 1, further comprising a pre-treatment layer between the negative active material layer and the protection layer.

6. The negative electrode of claim 5, wherein the pre-treatment layer is formed by plasma-treating the negative electrode using a gas, the gas being selected from the group consisting of oxygen, nitrogen and carbon dioxide, or by exposing the negative electrode to the gas.

7. The negative electrode of claim 5, wherein the pre-treatment layer comprises a metal or an inorganic material.

8. The negative electrode of claim 7, wherein the metal is selected from the group consisting of Al, Mg, K, Na, Ca, Sr, Ba, Si, Ge, Sb, Pb, In, Zn, Ni, Ti, Cu, Ag, Au, Pt, Fe, Co, Cr, W, and Mo.

9. The negative electrode of claim 7, wherein the inorganic material is selected from the group consisting of lithium nitride, lithium carbonate, lithium silicate, lithium borate, lithium aluminate, lithium phosphate, lithium phosphorous oxynitride, lithium silicosulfide, lithium germano sulfide, lithium lanthanum oxide, lithium titanium oxide, lithium borosulfide, lithium alumino sulfide, lithium phosphosulfide, and a mixture thereof.

10. The negative electrode of claim 1, wherein the current collector is a metal-deposited polymer film, the polymer film being selected from the group consisting of polyester, polyethylene, polypropylene, and polyimide.

11. The negative electrode of claim 1, wherein the protection layer comprises an ionic conductive polymer.

12. The negative electrode of claim 11, wherein the ionic conductive polymer is selected from the group consisting of polyethylene oxides, siloxanes, phosphazenes and a mixture thereof.

13. The negative electrode of claim 1, wherein the negative electrode is used in a lithium-sulfur battery.

14. A rechargeable lithium battery comprising:
a negative electrode comprising a current collector, a negative active material layer on one side of the current collector, a protection layer on the negative active material, and a releasing layer on the other side of the current collector, or on the protection layer;
a positive electrode comprising a positive active material; and
an electrolyte.

15. The rechargeable lithium battery of claim 1, wherein the releasing layer comprises a material selected from the group consisting of a silicon-included compound, polyalkylene oxide, polyolefin, polydiene, polyfluorocarbon, a mixture thereof, and a copolymer thereof.

16. The rechargeable lithium battery of claim 15, wherein the releasing layer includes the silicon-included compound.

17. The rechargeable lithium battery of claim 16, wherein the silicon-included compound is represented by formula 1: 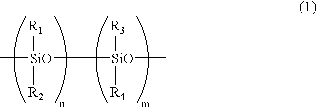
where R₁, R₂, R₃, and R₄ are identically or independently selected from the group consisting of C₁-C₁₈ linear alkyl, or branched alkyl, cyclic alkyl, alkenyl, aryl, aralkyl, halogenated alkyl, halogenated aryl, halogenated aralkyl, phenyl, mercaptan, methacrylate, acrylate, epoxy and vinyl ether; and
n and m are the same or different integers of 1 to 100,000.

18. The rechargeable lithium battery of claim 13, further comprising a pre-treatment layer between the negative active material layer and the protection layer.

19. The rechargeable lithium battery of claim 18, wherein the pre-treatment layer is formed by plasma-treating the negative electrode using a gas, the gas being selected from the group consisting of oxygen, nitrogen, and carbon dioxide, or by exposing the negative electrode to the gas.

20. The rechargeable lithium battery of claim 18, wherein the pre-treatment layer comprises a metal or an inorganic material.

21. The rechargeable lithium battery of claim 20, wherein the metal is selected from the group consisting of Al, Mg, K, Na, Ca, Sr, Ba, Si, Ge, Sb, Pb, In, Zn, Ni, Ti, Cu, Ag, Au, Pt, Fe, Co, Cr, W, and Mo.

22. The rechargeable lithium battery of claim 20, wherein the inorganic material is selected from the group consisting of lithium nitride, lithium carbonate, lithium silicate, lithium borate, lithium aluminate, lithium phosphate, lithium phosphorous oxynitride, lithium silicosulfide, lithium germanosulfide, lithium lanthanum oxide, lithium titanium oxide, lithium borosulfide, lithium alumino sulfide, lithium phosphosulfide, and a mixture thereof.

23. The rechargeable lithium battery of claim 14, wherein the current collector is a metal-deposited polymer film, the polymer film being selected from the group consisting of polyester, polyethylene, polypropylene and polyimide.

24. The rechargeable lithium battery of claim 14, wherein the protection layer comprises an ionic conductive polymer.

25. The rechargeable lithium battery of claim 24, wherein the ionic conductive polymer is selected from the group consisting of polyethylene oxides, siloxanes, phosphazenes, and a mixture thereof.

26. The rechargeable lithium battery of claim 14, wherein the positive active material is selected from the group consisting of elemental sulfur in an S₈form, a sulfur-based compound, and a mixture thereof.

27. The rechargeable lithium battery of claim 14, wherein the rechargeable lithium battery is a lithium-sulfur battery.

28. A method of preparing a negative electrode of a rechargeable lithium battery comprising:
forming a negative active material layer on a current collector;
forming a protection layer on the negative active material layer; and
covering the protection layer with a release paper or a release film to form a releasing layer.

29. The method of claim 28, wherein the release paper or the release film comprises a material selected from the group consisting of a silicon-included compound, polyalkylene oxide, polyolefin, polydiene, polyfluorocarbon, a mixture thereof, and a copolymer thereof.

30. The method of claim 29, wherein the release paper or the release film comprises the silicon-included compound.

31. The method of claim 30, wherein the silicon-included compound is represented by formula 1: 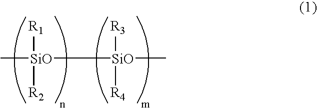
where R₁, R₂, R₃, and R₄ are identically or independently selected from the group consisting of C₁-C₁₈ linear alkyl, or branched alkyl, cyclic alkyl, alkenyl, aryl, aralkyl, halogenated alkyl, halogenated aryl, halogenated aralkyl, phenyl, mercaptan, methacrylate, acrylate, epoxy and vinyl ether; and
n and m are the same or different integers of 1 to 100,000.

32. The method of claim 28, further comprising plasma-treating the current collector using a gas or exposing the current collector to the gas to form a pre-treatment layer after forming the negative active material layer, the gas being selected from the group consisting of oxygen, nitrogen, and carbon dioxide.

33. The method of claim 32, wherein the pre-treatment layer comprises a metal or an inorganic material.

34. The method of claim 33, wherein the metal is selected from the group consisting of Al, Mg, K, Na, Ca, Sr, Ba, Si, Ge, Sb, Pb, In, Zn, Ni, Ti, Cu, Ag, Au, Pt, Fe, Co, Cr, W and Mo.

35. The method of claim 33, wherein the inorganic material is selected from the group consisting of lithium nitride, lithium carbonate, lithium silicate, lithium borate, lithium aluminate, lithium phosphate, lithium phosphorous oxynitride, lithium silicosulfide, lithium germanosulfide, lithium lanthanum oxide, lithium titanium oxide, lithium borosulfide, lithium alumino sulfide, lithium phosphosulfide and a mixture thereof.

36. The method of claim 28, wherein the current collector is a metal-deposited polymer film, the polymer film being selected from the group consisting of polyester, polyethylene, polypropylene, and polyimide.

37. The method of claim 28, wherein the protection layer comprises an ionic conductive polymer.

38. The method of claim 37, wherein the ionic conductive polymer is selected from the group consisting of polyethylene oxides, siloxanes, phosphazenes, and a mixture thereof.
